(19) United States
(12) Patent Application Publication
(10) Pub. No.: US 2006/0292411 A1
(43) Pub. Date: Dec. 28, 2006

(54) Fuel cell system

(75) Inventors: Tae-Hee Cho, Changwon (KR); Myung-Seok Park, Jinhae (KR); Hong Choi, Changwon (KR); Myeong-Ho Lee, Busan (KR); Kyu-Jung Kim, Seongnam (KR); Cheol-Hwan Kim, Gimhae (KR); Yong-Jun Hwang, Changwon (KR); Seung-Tae Ko, Daegu (KR); Seong-Geun Heo, Busan (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 10/596,919

(22) PCT Filed: Dec. 30, 2003
(86) PCT No.: PCT/KR03/02903

§ 371 Date: Jun. 29, 2006

(51) Int. Cl. H01M 8/04; H01M 8/02

(52) U.S. Cl. 429/26; 429/38; 429/24

(57) ABSTRACT

A fuel cell system comprising: a fuel cell stack (6) including an anode (2), a cathode (4), and an electrolyte membrane disposed therebetween; a fuel supplying unit connected with the anode of the fuel cell stack (6) by a fuel supplying line (14) for supplying hydrogen-including fuel to the anode (2); an air supplying unit (10) connected with the cathode of the fuel cell stack by an air supplying line (48) for supplying oxygen-including air to the cathode of the fuel cell stack; and a heating unit (12) for heating fuel supplied to the fuel cell stack into a proper temperature. According to this, a power source for driving the heating unit (12) is not required thus to enhance a performance of a fuel cell.

### TECHNICAL FIELD

The present invention relates to a fuel cell system, and more particularly, to a fuel cell system capable of enhancing a performance of a fuel cell by accelerating a reaction speed of a fuel cell.

### BACKGROUND ART

In general, a fuel cell system has been proposed as a substitution of fossil fuel and differently from a general cell (a second cell), it supplies fuel (hydrogen or hydrocarbon) to an anode and supplies oxygen to a cathode. Thus, the fuel cell system undergoes an electrochemical reaction between hydrogen and oxygen without a combustion reaction (oxidation reaction) of fuel and thereby directly converts an energy difference between before and after a reaction into electric energy.

As shown in FIG. 1, a fuel cell system in accordance with the conventional art comprises: a fuel cell stack 106 that an anode 102 and a cathode 104 are stacked with plural numbers in a state that an electrolyte membrane (not shown) is disposed therebetween in order to generate electric energy by an electrochemical reaction between hydrogen and oxygen are stacked with the plural number; a fuel tank 108 for supplying fuel to the anode 102; an oxidant supplying unit 110 for supplying oxidant to the cathode 104; and etc.

A fuel pump 112 for pumping fuel stored in the fuel tank 108 is installed between the fuel tank 108 and the anode 102 of the fuel cell stack 106.

As oxidant supplied to the cathode 104, oxygen-including air is used. The oxidant supplying unit 110 comprises: an air compressor 114 for supplying air to the cathode 104 of the fuel cell stack 106; an air filter 116 for filtering air supplied to the fuel cell stack 106; and a humidifier 118 for humidifying air supplied to the fuel cell stack 106.

Processes for generating electric energy by supplying fuel to the conventional fuel cell will be explained as follows.

When the fuel pump 112 is operated by a control signal of a controller (not shown), fuel stored in the fuel tank 108 is pumped thus to be supplied to the anode 102 of the fuel cell stack 106. Also, when the air compressor 114 is operated, air filtered by the air filter 116 passes through the humidifier 118 thus to be humidified and is supplied to the cathode 104 of the fuel cell stack 106.

Once fuel and air are supplied to the fuel cell stack 106, an electrochemical oxidation of hydrogen is performed in the anode 102 and an electrochemical deoxidation of oxygen is performed in the cathode 104 in a state that the electrolyte membrane (not shown) is interposed between the anode 102 and the cathode 104. At this time, electricity is generated due to movement of generated electrons, and is supplied to a load 120.

That is, an electrochemical oxidation reaction of hydrogen such as BH₄⁻+8OH⁻->BO₂⁻+6H₂O+8e⁻ is generated in the anode 102 and ions generated by oxidation/deoxidation reaction are transmitted to the cathode 104 through the electrolyte membrane. Also, an electrochemical deoxidation reaction of oxygen such as 2O₂+4H₂O+8e⁻->8OH⁻ is generated in the cathode 104. Accordingly, a total reaction is BH₄⁻+2O₂->2H₂O+BO₂⁻.

In the fuel cell system, temperature of fuel and air supplied to the fuel cell stack 106 greatly influence on a performance of a fuel cell. Accordingly, an additional heating unit for increasing temperature of fuel supplied to the anode 102 from the fuel tank 108 and air supplied to the cathode 104 from the air supplying unit 110 into a certain temperature is provided.

However, in the conventional fuel cell system, an additional heating unit for heating fuel and air supplied to the fuel cell stack has to be provided, and current generated from the fuel cell has to be used in order to drive the heating unit, thereby increasing a consumption power.

### DISCLOSURE OF THE INVENTION

Therefore, it is an object of the present invention to provide a fuel cell system requiring no power source for driving a heating unit by heating fuel and air using hydrogen generated from a fuel cell stack and thereby capable of enhancing a performance of a fuel cell.

Another object of the present invention is to provide a fuel cell system capable of enhancing a performance of a fuel cell by increasing temperature of fuel by using reaction heat generated at the time of fuel mixing and thereby requiring no heating unit for increasing temperature of the fuel and a power source for driving the heating unit.

To achieve these objects, there is provided a fuel cell system comprising: a fuel cell stack including an anode, a cathode, and an electrolyte membrane disposed therebetween; a fuel supplying unit connected with the anode of the fuel cell stack by a fuel supplying line for supplying hydrogen-including fuel to the anode; an air supplying unit connected with the cathode of the fuel cell stack by an air supplying line for supplying oxygen-including air to the cathode of the fuel cell stack; and a heating unit for heating fuel supplied to the fuel cell stack into a proper temperature.

The heating unit is connected to the anode of the fuel cell stack by a hydrogen supplying line and is composed of a hydrogen combustor for heating fuel and air supplied to the fuel cell stack into a proper level by using hydrogen generated from the anode after reaction.

The hydrogen combustor is constituted with a housing for respectively passing fuel supplied to the anode of the fuel cell stack and air supplied to the cathode; a blowing fan installed at the housing for blowing external air into the housing; and a heat generating unit installed in the housing and for heating fuel and air which pass through inside of the housing by generating heat after reaction with hydrogen generated from the anode of the fuel cell stack.

The heating unit is composed of a fuel kit for supplying fuel powder to a fuel tank before operating a fuel cell in order to increase temperature of fuel by using heat generated when fuel powder is mixed with water stored in the fuel tank of the fuel supplying unit.

The fuel kit is composed of a container for storing fuel powder; and an open/close unit installed at an inlet of the container for opening the inlet of the container at the time of supplying the fuel powder to the fuel tank.

The heating unit is composed of a thermoelectric module for heating fuel supplied to the anode of the fuel cell stack from the fuel tank of the fuel supplying unit.

### BRIEF DESCRIPTION OF THE DRAWINGS

FIG. 1 is a construction view of a fuel cell system in accordance with the conventional art;

FIG. 2 is a construction view of a fuel cell system according to one embodiment of the present invention;

FIG. 3 is a partially-cut perspective view of a heating unit of the fuel cell system according to one embodiment of the present invention;

FIG. 4 is a sectional view of the heating unit of the fuel cell system according to one embodiment of the present invention;

FIG. 5 is a block diagram showing a controller of the heating unit of the fuel cell system according to one embodiment of the present invention;

FIG. 6 is a sectional view of a heating unit according to a second embodiment of the present invention;

FIGS. 7 and 8 are sectional views showing an operational state of the heating unit according to the second embodiment of the present invention;

FIG. 9 is a sectional view taken along line IX-IX of FIG. 8.;

FIG. 10 is a graph showing a process for increasing temperature of fuel of a fuel cell system according to a second embodiment of the present invention; and

FIG. 11 is a sectional view showing an operation of a heating unit according to a third embodiment of the present invention.

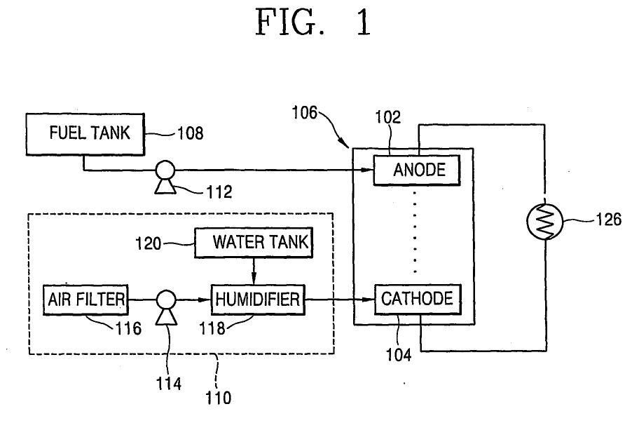

### MODES FOR CARRYING OUT THE PREFERRED EMBODIMENTS

A fuel cell system according to the present invention will be explained in more detail as follows.

Even if the fuel cell system according to the present invention can have plural embodiments, the most preferable embodiment will be explained hereinafter.

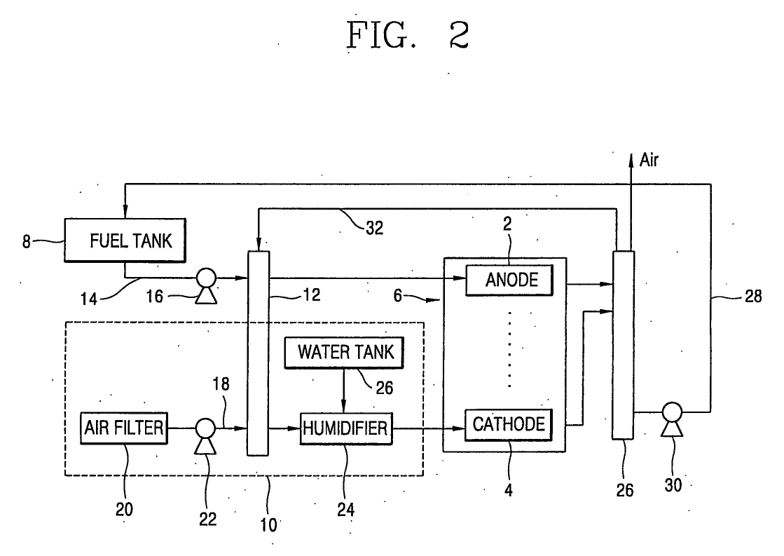

FIG. 2 is a construction view of a fuel cell system according to one embodiment of the present invention.

The fuel cell system according to the present invention comprises: a fuel cell stack 6 that an anode 2 and a cathode 4 are stacked with plural numbers in order to generate electric energy by an electrochemical reaction between hydrogen and oxygen in a state an electrolyte membrane is disposed therebetween; a fuel tank 8 for storing fuel supplied to the anode 2; an air supplying unit 10 for supplying oxygen-including air to the cathode 4; a fuel recycling apparatus for recycling fuel exhausted from the fuel cell stack 6 into the fuel tank 8; and a heating unit 12, a hydrogen combustor for heating fuel and air supplied to the fuel cell stack 6.

The fuel tank 8 stores aqueous solution of NaBH₄, and is connected with the anode 2 of the fuel cell stack 6 by a fuel supplying line 14. At one side of the fuel supplying line 14, a fuel pump 16 for pumping fuel stored in the fuel tank 8 is installed.

The air supplying unit 10 comprises: an air supplying line 18 for inducing atmospheric air to the cathode 4 of the fuel cell stack 8; an air filter 20 installed at an inlet of the air supplying line 18 for filtering air sucked into the air supplying line 18; an air pump 22 installed at one side of the air supplying line 18 for generating a suction power for sucking external air; and a humidifier 24 for humidifying air sucked by the air pump 22. A water tank 26 for supplying water to the humidifier 24 is installed at the humidifier 24.

When hydrogen-including fuel and oxygen-including air are respectively supplied to the anode 2 and the cathode 4 of the fuel cell stack 6 from the fuel tank 8 and the air supplying unit 10, a following reaction is performed in the fuel cell stack 6 thus to generate current.

That is, in the anode 2, an electrochemical oxidation reaction BH₄⁻+8OH⁻->BO₂⁻+6H₂O+8e⁻ is performed thus to transmit ions generated from oxidation and deoxidation reaction to the cathode 4 through the electrolyte membrane, and in the cathode 4, an electrochemical deoxidation reaction of the supplied air 2O₂+4H₂O+8e⁻->8OH⁻ is performed.

Accordingly, a total reaction is expressed as BH₄⁻+2O₂->2H₂O+BO₂⁻.

While these reactions are performed, a side reaction such as 2H₂O+NaBH₄->NaBO₂+4H₂ is simultaneously performed in the anode 2.

The fuel recycling includes a gas/liquid separator 26 for separating fuel exhausted after reaction in the anode 2 and the cathode 4 into gas and liquid, a fuel recycling line 28 for recycling fuel of a liquid state exhausted from the gas/liquid separator 26 into the fuel tank 8, and a recycling pump 30 installed at the fuel recycling line 28 for pumping recycled liquid fuel to the fuel tank 8.

The NaBO₂+4H₂ generated after reaction in the anode 2 of the fuel cell stack 6 is divided into gas and liquid by the gas/liquid separator 26. As the result, water and NaBO₂ are recycled to the fuel tank 8 through the fuel recycling line 28, whereas hydrogen is exhausted outside. The hydrogen exhausted from the gas/liquid separator 26 is supplied to the heating unit 12 through the hydrogen supplying line 32 thus to be used as a heat source of the heating unit 12.

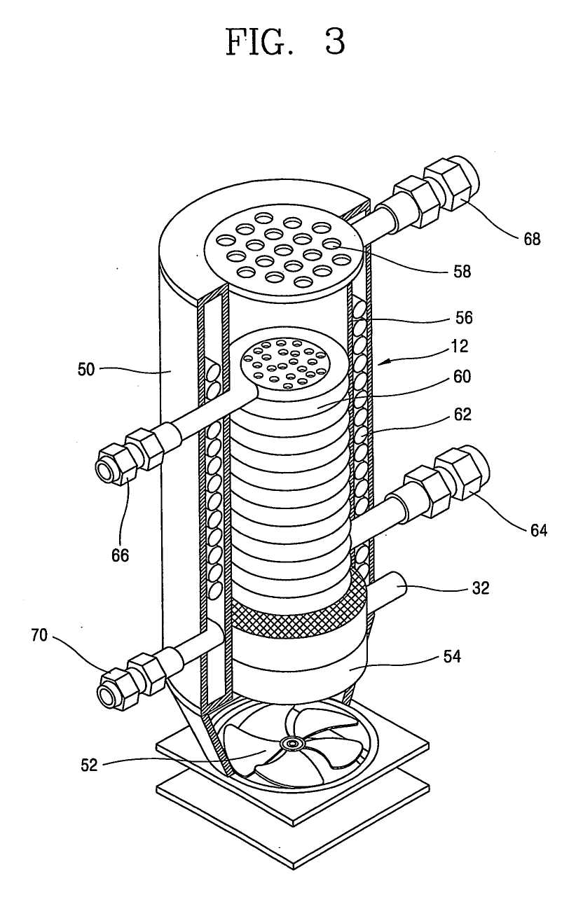

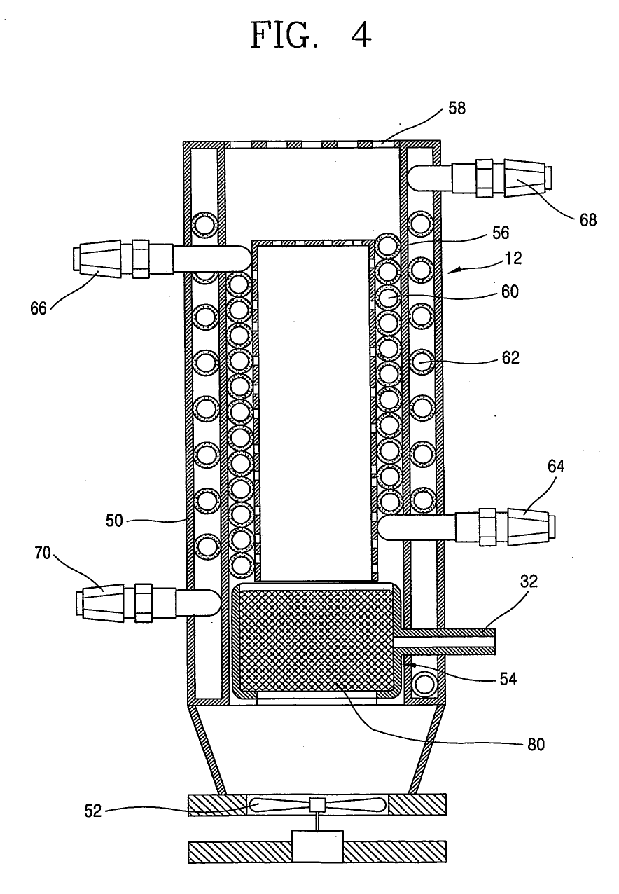

FIG. 3 is a partially-cut perspective view of the heating unit of the fuel cell system according to one embodiment of the present invention.

As shown in FIG. 3, the heating unit 12 is constituted with a housing 50 to which the fuel supplying line 14, the air supplying line 18, and the hydrogen supplying line 32 are connected; a blowing fan 52 installed at a lower portion of the housing 50 for blowing external air into the housing 50; and a heat generating unit 54 installed in the housing 50 and for heating fuel and air which pass through inside of the housing 50 by generating heat after reaction with hydrogen supplied from the gas/liquid separator 26.

The housing 50 is formed as a cylindrical shape having a certain diameter and height, and a division body 56 of a cylindrical shape having a diameter smaller than that of the housing 50 is installed in the housing 50 with a constant interval from an inner circumferential surface of the housing 50. A plurality of exhaustion holes 58 for exhausting gas which has finished a heating operation outside are formed at an upper portion of the housing 50, and the heat generating unit 54 and the blowing fan 52 are installed at a lower portion of the housing 50.

A fuel pipe 60 is arranged as a coil form inside the division body 56, and an air pipe 62 is arranged as a coil form outside the division body 56.

Since gas heated by passing through the heat generating unit 54 passes through inside of the division body 56, the fuel pipe 60 is in directly contact with gas thus to be heated and the air pipe 62 is in indirectly contact with gas through the division body 56 thus to be heated. Accordingly, fuel of a liquid state and air of a gas state are heated into the same temperature.

One end portion of the fuel pipe 60 is connected with a fuel inlet 64, and another end portion thereof is connected to a fuel outlet 66. One end portion of the air pipe 62 is connected to an air inlet 68, and another end portion thereof is connected to an air outlet 70.

Also, the fuel inlet 64 and the fuel outlet 66 are respectively connected with the fuel supplying line 14, and the air inlet 68 and the air outlet 70 are respectively connected with the air supplying line 18 which connects the air filter 20 and the humidifier 24.

The blowing fan 52 mounted at the lower portion of the housing 50 uses current generated from the fuel cell stack 6 as a power source, blows external air into the housing 50 and the heat generating unit 54.

Herein, a power source used at the blowing fan 52 is too less thus to scarcely influence on a performance of the fuel cell system 6.

The heat generating unit 54 is installed at the lower portion of the housing 50 and is formed as a honeycomb type that a catalyst 80 is attached to inside thereof. An igniter for igniting (not shown) is installed at one side of the heat generating unit 54, and the heat generating unit 54 is connected with the hydrogen supplying line 32 thus to be provided with hydrogen from the gas/liquid separator 26. The heat generating unit 54 generates heat by a following operation. First, oxygen-including air blown by the blowing fan 52 is introduced into a lower portion of the heat generating unit 54 and hydrogen is supplied from the gas/liquid separator 26 through the hydrogen supplying line 32. Under this state, ignition is performed in the igniter and thereby a reaction among oxygen, hydrogen, and a catalyst is performed in the heat generating unit 54. According to this, the heat generating unit generates heat. Herein, the used catalyst is preferably a platinum catalyst.

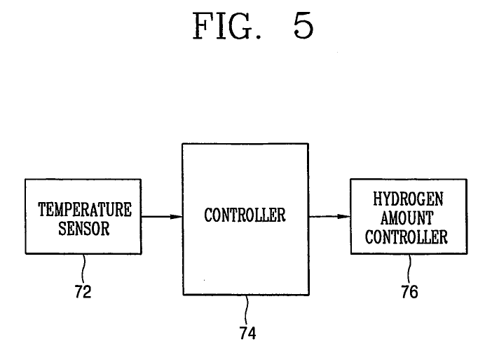

FIG. 5 is a block diagram showing a controller of the heating unit of the fuel cell system according to one embodiment of the present invention.

The heating unit 12 is provided with a controller for maintaining temperature of the heated air and fuel as a proper level and thereby supplying to the fuel cell stack 6.

The controller is composed of a temperature sensor 72 installed at one side of the hydrogen combustor, the heating unit, for detecting temperature of the hydrogen combustor; a hydrogen supply amount controller 76 installed at the hydrogen supplying line 32 for controlling a hydrogen amount supplied to the hydrogen combustor; and a controller 74 for controlling the hydrogen supply amount controller 76 according to a signal applied from the temperature sensor 72.

Operation of the fuel cell provided with the heating unit according to one embodiment of the present invention will be explained as follows.

Hydrogen-including NaBH₄ is supplied to the anode 2 and at the same time oxygen-including air is supplied to the cathode 4 thus to be reacted with the electrolyte membrane, thereby forming ions. While the ions causes an electrochemical reaction thus to form water, electrons are generated in the anode 2 and moves to the cathode 4 thus to generate electricity.

This will be explained in more detail as follows. In the anode 2, an electrochemical oxidation reaction BH₄⁻+8OH⁻->BO₂⁻+6H₂O+8e⁻ is performed, and in the cathode 4, an electrochemical deoxidation reaction of the supplied air 2O₂+4H₂O+8e⁻->8OH⁻ is performed.

While these reactions are performed, a side reaction such as 2H₂O+NaBH₄->NaBO₂+4H₂ is performed in the anode 2 thus to generate hydrogen (4H₂) in fuel (aqueous solution of NaBH₄). According to this, the generated hydrogen is exhausted from the anode 2 with the NaBO₂. At this time, the NaBO₂ and hydrogen exhausted from an outlet of the anode 2 pass through the gas/liquid separator 26 thus to be separated into gas and liquid. In this process, water and NaBO₂ of a liquid state are recycled into the fuel tank 8 through the fuel recycling line 28, whereas hydrogen of a gas state is supplied to the heating unit 12 through the hydrogen supplying line 42. The heating unit 12 uses the supplied hydrogen thus to heat fuel and air into a proper level.

That is, when oxygen-including air is blown to inside of the housing 50 by the blowing fan 52 and hydrogen exhausted from the gas/liquid separator 26 is supplied to the heat generating unit 54, the hydrogen, the oxygen, and the catalyst installed at the heat generating unit 54 react reciprocally thus to generate heat in the heating unit 12.

By the heat generation in the heat generating unit 54, air blown to inside of the housing 50 by the blowing fan 52 is heated and the heated air passes through inside of the housing 50 thus to heat the fuel pipe 60 and the air pipe 62. Then, air which has finished the heating operation is exhausted outside through the exhaustion holes 58.

Herein, the air heated by passing through the heat generating unit 54 directly heats the fuel pipe 60 and indirectly heats the air pipe 62 by the division body 56, so that fuel of a liquid state passing through the fuel pipe 60 and air of a gas state passing through the air pipe 62 have the almost same temperature each other and are respectively supplied to the anode 2 and the cathode 4.

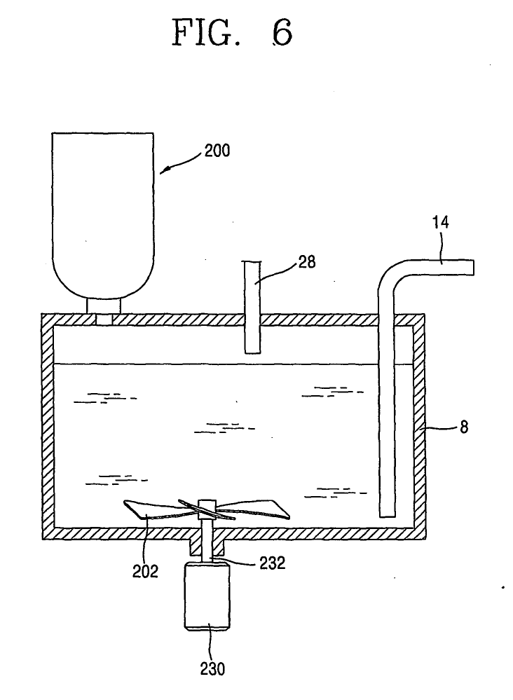

FIG. 6 is a sectional view of a heating unit of the fuel cell system according to a second embodiment of the present invention.

The heating unit according to the second embodiment is to increase temperature of fuel into a proper level by using reaction heat generated when fuel powder is mixed with water stored in the fuel tank 8 before operating the fuel cell. The heating unit is composed of a fuel kit 200 for storing fuel powder; and a blade 202 installed at one side of the fuel tank 8 for well mixing fuel powder with water when fuel powder is supplied into the fuel tank 8 from the fuel kit 200.

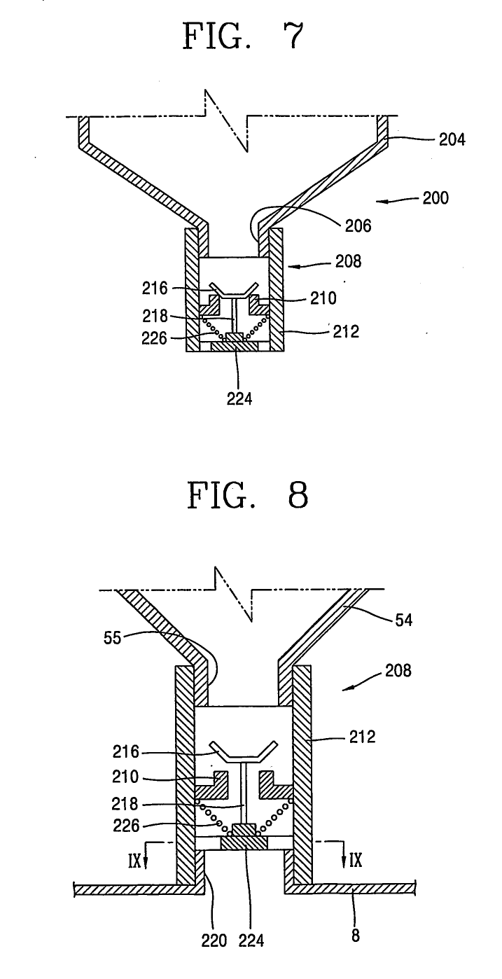

As shown in FIGS. 7 and 8, the fuel kit 200 is composed of a container 204 for storing fuel powder; and an open/close unit 208 installed at an inlet 206 of the container for maintaining a closed state at ordinary times and opening the inlet 206 of the container when the fuel kit 200 is mounted at the fuel tank 8 thus supplying the fuel powder stored in the container 204 into the fuel tank 8.

The open/close unit 208 is constituted with a cap body 212 hermetically mounted at the inlet 206 of the container and provided with a valve seat 210 therein; a valve plate 216 contacting the valve seat 210 or separated from the valve seat 210 for performing an open/close operation; a stopping plate 224 connected with the valve plate 216 by a connection rod 218 and stopped by the fuel supplying unit 220 formed at the upper surface of the fuel tank 8, for separating the valve plate 216 from the valve seat 210; and a spring 226 installed at the stopping plate 224 and the valve seat 210 for providing an elasticity force by which the valve plate 216 is adhered to the valve seat 210.

The valve plate 216 is preferably formed as a ‘V’ shape in order to be easily adhered to the valve seat 210.

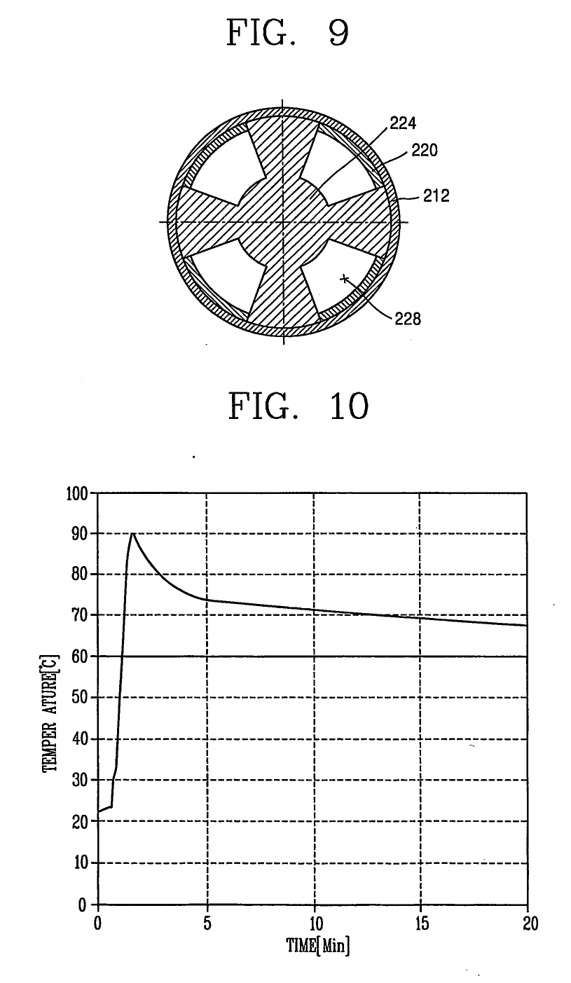

Also, as shown in FIG. 9, the stopping plate 224 is integrally 10 formed with the connection rod 218, and is provided with a plurality of penetration holes 228 for passing fuel powder at a circumference thereof. Also, the spring 226 is preferably formed of a coil spring that one side of the spring 226 is supported at a lower surface of the valve seat 210 and another side thereof is supported at an upper surface of the stopping plate 224.

The fuel supplying unit 220 is protruding from an upper portion of the fuel tank 8 as a cylindrical shape. When the stopping plate 224 is stopped at an upper surface of the fuel supplying unit 220, the fuel kit 200 is opened to supply fuel powder into the fuel tank 8.

Operation of the open/close unit 208 will be explained. First, when the cap body 212 is inserted into the fuel supplying unit 220 of the fuel tank 8, the stopping plate 224 is stopped at the upper surface of the fuel supplying unit 220 thus to move the connection rod 218 upwardly and to separate the valve plate 216 from the valve seat 210. Then, fuel powder stored in the container 204 is supplied into the fuel tank 8 through the fuel supplying unit 220 thus to be mixed with water.

The fuel powder in the fuel kit 200 is powder that NaOH and BH₄ are properly mixed each other. When the NaOH is mixed with water, a reaction is performed as a following reaction formula and heat is generated.
Reaction formula: NaOH+H₂O->NaOH(H₂O)+9˜13 kcal/mol

The blade 202 is rotatably installed at a lower side of the fuel tank 8 and connected with a driving motor 230 for generating a driving force by a rotation shaft 232, thereby being rotated by a rotation of the driving motor 230 and mixing water stored in the fuel tank 8 with NaOH and BH₄ powder supplied to the fuel tank 8.

Operation of the fuel cell system according to the present invention will be explained as follows.

First, before driving the fuel cell, NaOH and BH₄ powder are supplied to the fuel tank 8 thus to prepare fuel aqueous solution. At this time, water stored in the fuel tank 8 is mixed with the fuel powder thus to generate heat.

That is, when the fuel kit 200 where the NaOH and BH₄ powder are stored is mounted at the fuel supplying unit 220 of the fuel tank 8, the open/close unit 208 mounted at the inlet 206 of the container is operated in the same way as the aforementioned way. According to this, the inlet 206 of the container is opened thus to supply the NaOH and BH₄ powder stored in the container 204 to the fuel tank.

Then, as shown in the reaction formula: NaOH+H₂O->NaOH (H₂O)+9˜13 kcal/mol, water is reacted with NaOH thus to increase temperature of fuel into a constant temperature. At this time, the blade 202 is rotated in order to make the water be well mixed with the NaOH and BH₄ powder.

The operation for increasing temperature of fuel will be explained by experimental data. As shown in FIG. 10, under a state that water stored in the fuel tank 8 maintains approximately 22° C., NaOH and BH₄ powder is supplied to the fuel tank 8. According to this, temperature of the fuel is increased into approximately 90° C. and is gradually lowered as time lapses. Herein, an optimum temperature of the fuel is 60° C.-80° C., so that the fuel cell system is driven at approximately 70° C. thus to supply the fuel to the fuel cell stack 6. As shown in FIG. 10, when approximately 15 minutes lapse after the NaOH and BH₄ powder is supplied to the fuel tank 8, temperature of the fuel reaches 70° C. Therefore, it is preferable to drive the fuel cell after approximately 15 minutes after the NaOH and BH₄ powder is supplied to the fuel tank 8.

When the above process for increasing temperature of fuel has been finished, the fuel pump 16 is operated thus to supply fuel from the fuel tank 8 to the anode 2 and at the same time the air pump 22 is operated thus to supply air from the air supplying unit to the cathode 4. Then, the fuel and air are reacted with the electrolyte membrane thus to form ions. While the ions causes an electrochemical reaction thus to form water, electrons are generated in the anode 2 and moves to the cathode 4 thus to generate electricity.

This will be explained in more detail as follows. In the anode 2, an electrochemical oxidation reaction BH₄⁻+8OH⁻->BO₂⁻+6H₂O+8e⁻ is performed, and in the cathode 4, an electrochemical deoxidation reaction of the supplied air 2O₂+4H₂O+8e⁻->8OH⁻ is performed.

The fuel which has finished said process is exhausted to the gas/liquid separator 26, and the gas/liquid separator 26 separates gas from liquid thus to exhaust gas outside and to recycle liquid fuel into the fuel tank 8 through the fuel recycling line 28.

At this time, since temperature of fuel exhausted after reaction in the fuel cell stack 6 has been increased, temperature of fuel recycled into the fuel tank 8 maintains a proper level. Accordingly, while the fuel cell is operated, temperature of fuel is maintained as a proper level.

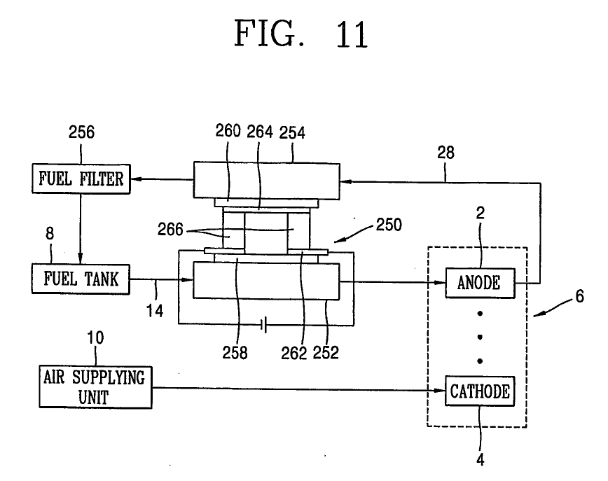

FIG. 11 is a sectional view showing a heating unit of the fuel cell system according to a third embodiment of the present invention.

The heating unit according to the third embodiment is composed of a thermoelectric module 250 installed at the fuel supplying line 14 and the fuel recycling line 28 for heating fuel supplied to the fuel cell stack 6 from the fuel tank 8 and cooling fuel recycled into the fuel tank 8 from the fuel cell stack 6.

At the fuel supplying line 14, a heating container 252 for heating passing fuel supplied to the fuel cell stack 6 by a heat emitting operation of the thermoelectric module 250 is installed, and at the fuel recycling line 28, a cooling container 254 for cooling passing fuel recycled into the fuel tank 8 by a heat absorbing operation of the thermoelectric module 250 is installed.

Also, a fuel filter 256 for removing NaBO₂ crystallized by passing through the cooling container 254 is installed at the fuel recycling line 28 between the cooling container 254 and the fuel tank 8.

The reaction aforementioned in the first embodiment is consecutively performed in the fuel cell stack 6, and a reaction such as 2H₂O+NaBH₄->NaBO₂+4H₂ is simultaneously performed in the anode 2.

The NaBO₂ exhausted from the fuel cell stack 6 is dissolved in a constant high temperature and crystallized in a constant low temperature thus to block the fuel recycling line 28 or the fuel supplying line 14. To prevent this, a heat absorbing operation of the thermoelectric module 250 is used in order to remove the NaBO₂ before it is recycled into the fuel tank 8.

That is, when fuel exhausted from the fuel cell stack 6 is cooled by using a heat absorbing operation of the thermoelectric module 250, NaBO₂ is crystallized and the crystallized BO₂⁻ is filtered by the fuel filter 256.

The thermoelectric module 250 uses the Peltier effect and comprises: a high temperature ceramic board 258 attached to the heating container 252; a low temperature ceramic board 260 attached to the cooling container 254; a first electrode 262 installed at the high temperature ceramic board 258 and to which current is applied; a second electrode 264 installed at the low temperature ceramic board 260; and an n/p type thermoelectric semiconductor 266 aligned between the first electrode 262 and the second electrode 264. When current is applied to the n/p type thermoelectric semiconductor 266, temperature difference is generated at both surfaces of the module by a thermoelectric effect thus to generate a heat emitting operation through the high temperature ceramic board 258 and to generate a heat absorbing operation through the low temperature ceramic board 260.

Operation of the fuel cell system according to the third embodiment will be explained as follows.

If current is applied to the thermoelectric module 250 when fuel is supplied to the anode 2 of the fuel cell stack through the fuel supplying line 14 from the fuel tank 8, a heat emitting operation is generated through the high temperature ceramic board 258 of the thermoelectric module 250 thus to heat the heating container 252. According to this, fuel which passes through the heating container 252 is heated into a proper level thus to be supplied to the fuel cell stack 6.

Also, when fuel exhausted from the fuel cell stack 6 after reaction is introduced into the cooling container 254 through the fuel recycling line 28, the cooling container 254 is cooled through the low temperature ceramic board 260 by a heat absorbing operation of the thermoelectric module 250. Then, fuel which passes through the cooling container 254 is cooled, so that NaBO₂ contained in the fuel is crystallized and BO₂⁻ crystal is filtered by the fuel filter 256.

In the fuel cell system according to the present invention, fuel and air supplied to the fuel cell stack are heated by using hydrogen generated from the anode. According to this, an additional power source for heating fuel and air is not required thus to enhance a performance of the fuel cell system.

Also, in the fuel cell system according to the present invention, fuel is supplied to the fuel cell stack under a state that temperature of the fuel is increased into a proper level, thereby enhancing a performance of the fuel cell.

Besides, according to the present invention, NaBO₂ contained in fuel recycled into the fuel tank from the fuel cell stack is removed thus to prevent a phenomenon that the fuel supplying line or the fuel recycling line are blocked and to have a smooth operation in fuel supplying and fuel recycling, thereby enhancing a reliability of the fuel cell.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A fuel cell system comprising:
a fuel cell stack including an anode, a cathode, and an electrolyte membrane disposed therebetween;
a fuel supplying unit connected with the anode of the fuel cell stack by a fuel supplying line for supplying hydrogen-including fuel to the anode;
an air supplying unit connected with the cathode of the fuel cell stack by an air supplying line for supplying oxygen-including air to the cathode of the fuel cell stack; and
a heating unit for heating fuel supplied to the fuel cell stack into a proper temperature.

2. The system of claim 1, further comprising a gas/liquid separator for obtaining hydrogen generated from the fuel cell stack after reaction.

3. The system of claim 1, wherein the heating unit is connected to the anode of the fuel cell stack by a hydrogen supplying line and is composed of a hydrogen combustor for heating fuel and air supplied to the fuel cell stack into a proper level by using hydrogen generated from the anode after reaction.

4. The system of claim 3, wherein the hydrogen combustor comprises:
a housing for respectively passing fuel supplied to the anode of the fuel cell stack and air supplied to the cathode;
a blowing fan installed at the housing for blowing external air into the housing; and
a heat generating unit installed in the housing and for heating fuel and air which pass through inside of the housing by generating heat after reaction with hydrogen generated from the anode of the fuel cell stack.

5. The system of claim 4, wherein a fuel pipe through which fuel passes is arranged as a coil form and an air pipe through which air passes is arranged as a coil form in the housing.

6. The system of claim 5, wherein the fuel pipe and the air pipe are separated from each other by a division body.

7. The system of claim 6, wherein the fuel pipe is disposed inside the division body thus to directly receive heat generated from the heat generating unit, and the air pipe is disposed outside the division body thus to indirectly receive heat generated from the heat generating unit.

8. The system of claim 7, wherein one end portion of the fuel pipe is connected to a fuel inlet and another end portion thereof is connected to a fuel outlet, and the fuel inlet is disposed at an upper side of the housing and the fuel outlet is disposed at a lower side of the housing.

9. The system of claim 7, wherein one end portion of the fuel pipe is connected to a fuel inlet and another end portion thereof is connected to a fuel outlet, and the fuel inlet and the fuel outlet are respectively disposed at an upper side of the housing.

10. The system of claim of claim 4, wherein the blowing fan is rotatably installed at a lower portion of the housing, and exhaustion holes for exhausting air which has finished a heating operation while passing through the housing outwardly are formed at an upper portion of the housing.

11. The system of claim 4, wherein the blowing fan uses electric energy generated from the fuel cell stack as a power source.

12. The system of claim 4, wherein the heat generating unit is provided with catalyst attached to inside thereof and is formed to introduce oxygen-including air blown by the blowing fan thus to generate heat in accordance with that the hydrogen, the oxygen, and the catalyst reciprocally react.

13. The system of claim 12, wherein the catalyst is formed as a honeycomb type, an igniter for igniting is installed at one side of the catalyst, and the heat generating unit is connected to the hydrogen supplying line thus to be provided with hydrogen from the gas/liquid separator.

14. The system of claim 4, wherein the hydrogen combustor is provided with a controller for maintaining temperature of the heated air and fuel as a proper level and thereby supplying to the fuel cell stack.

15. The system of claim 14, wherein the controller comprises:
a temperature sensor installed at one side of the hydrogen combustor for detecting temperature of the hydrogen combustor;
a hydrogen supply amount controller installed at the hydrogen supplying line for controlling a hydrogen amount supplied to the hydrogen combustor; and
a controller for controlling the hydrogen supply amount controller according to a signal applied from the temperature sensor.

16. The system of claim 1, wherein the heating unit is composed of a fuel kit for supplying fuel powder to a fuel tank before operating a fuel cell in order to increase temperature of fuel by using heat generated when fuel powder is mixed with water stored in the fuel tank of the fuel supplying unit.

17. The system of claim 16, wherein the fuel kit comprises:
a container for storing fuel powder; and
an open/close unit installed at an inlet of the container for opening the inlet of the container at the time of supplying the fuel powder to the fuel tank.

18. The system of claim 17, wherein the open/close unit comprises:
a cap body mounted at the inlet of the container and provided with a valve seat therein;
a valve plate contacting the valve seat or separated from the valve seat for performing an open/close operation;
a stopping plate connected with the valve plate for separating the valve plate from the valve seat when the fuel kit is mounted at the fuel tank; and
a spring installed between the stopping plate and a lower surface of the valve seat for providing an elasticity force by which the valve plate is adhered to the valve seat.

19. The system of claim 18, wherein an upper surface of the fuel tank is provided with a fuel supplying unit into which the cap body is inserted and at which the stopping plate is stopped for supplying fuel stored in the fuel kit into the fuel tank.

20. The system of claim 19, wherein the fuel supplying unit is protruding from the upper surface of the fuel tank as a cylindrical shape, a stopping surface for stopping the stopping plate is formed at an upper surface of the fuel supplying unit, and a supply hole to which fuel powder is supplied is formed at the stopping surface.

21. The system of claim 18, wherein the valve plate is preferably formed as a ‘V’ shape in order to be easily adhered to the valve seat.

22. The system of claim 18, wherein the stopping plate is provided with a plurality of penetration holes for passing fuel powder at a circumference thereof.

23. The system of claim 18, wherein the spring is preferably a coil spring installed between an upper surface of the stopping plate and a lower surface of the valve seat.

24. The system of claim 17, wherein a blade for well mixing fuel powder with water when fuel powder is supplied into the fuel tank from the fuel kit is installed at one side of the fuel tank.

25. The system of claim 24, wherein the blade is rotatably installed at a lower portion of the fuel tank and connected with a driving motor for generating a driving force by a rotation shaft.

26. The system of claim 17, wherein the fuel powder is mixed powder between NaOH and BH₄.

27. The system of claim 1, wherein the heating unit is composed of a thermoelectric module for heating fuel supplied from a fuel tank of the fuel supplying unit to the anode of the fuel cell stack.

28. The system of claim 27, wherein a heating container contacting the thermoelectric module and for heating fuel by a heat emitting operation of the thermoelectric module is installed at the fuel supplying line.

29. The system of claim 27, wherein a cooling container for cooling fuel and a fuel filter for filtering NaBO₂ crystallized in the cooling container are installed at a fuel recycling line for recycling fuel into the fuel tank from the fuel cell stack.

30. The system of claim 29, wherein the cooling container is provided with a low temperature ceramic board of the thermoelectric module thus to be cooled by a heat absorbing operation of the thermoelectric module.

31. The system of claim 29, wherein the fuel filter comprises:
a case mounted at the fuel recycling line which connects the cooling container and the fuel tank; and
a filtering net installed in the case and for filtering crystallized NaBO₂.
